(19) United States
(12) Patent Application Publication
(10) Pub. No.: US 2022/0251685 A1
(43) Pub. Date: Aug. 11, 2022

(54) METALLIC POWDER MIXTURE FOR BUILD-UP OR REPAIR

(71) Applicant: Siemens Energy Global GmbH & Co. KG, Munich, Bayern (DE)

(72) Inventors: Bernd Burbaum, Falkensee (DE); Henning Hanebuth, Pliening OT Gelting (DE)

(73) Assignee: Siemens Energy Global GmbH & Co. KG, Munich, Bayern (DE)

(21) Appl. No.: 17/613,047

(22) PCT Filed: May 5, 2020
(86) PCT No.: PCT/EP2020/062380

§ 371 Date: Nov. 20, 2021

(30) Foreign Application Priority Data
May 28, 2019 (EP) 19176980.1

(51) Int. Cl. C22C 19/05; B33Y 70/00

(52) U.S. Cl. CPC C22C 19/055; C22C 19/057; B22F 10/28; B33Y 70/00; C22C 19/056

(57) ABSTRACT

A composition of a nickel-based alloy mixture which can be used for welding via especially liquid metal deposition or as a powder bed of an additive manufacturing method. The metallic powder mixture includes a cobalt (Co) or nickel (Ni) based super alloy, a NiCoCrAlY—X-composition wherein X=Silicon (Si), Tantalum (Ta), Rhenium (Re) and/or Iron (Fe), a metallic braze material, wherein the melting point of the braze material is at least 10K lower than the melting point of the cobalt (Co) or nickel (Ni) based superalloy.

### CROSS REFERENCE TO RELATED APPLICATIONS

This application is the US National Stage of International Application No. PCT/EP2020/062380 filed 5 May 2020, and claims the benefit thereof. The International Application claims the benefit of European Application No. EP19176980 filed 28 May 2019. All of the applications are incorporated by reference herein in their entirety.

### FIELD OF INVENTION

The invention relates to a composition of a nickel based alloy mixture which can be used for welding via especially liquid metal deposition or as a powder bed of an additive manufacturing method.

### BACKGROUND OF INVENTION

For a blade tip repair with Laser Metal Deposition (LMD) standard alloys Inconel 625 and Merl 72 are used. The oxidation resistance of both alloys at high temperatures T>1273K is not better than the base material Alloy247.

### SUMMARY OF INVENTION

Therefore, aim of the invention is to overcome the problem described above.

The problem is solved by a material, a powder, a method and a product as claimed.

The invention disclosure deals with the Laser Metal Deposition using powder additive material.

This material mixture can advantageously be used for blade tip repair with increased oxidation resistance in comparison to most currently used alloys.

The oxidation resistance of the developed material mixture is better than the base material Alloy247.

A braze material has always a melting point at least 10K, especially at least 20K lower than the nickel or cobalt based superalloy.

The powder mixture can be advantageously welded using a standard power cladding process or used for any alternative manufacturing process, especially like SLM or SLS.

Advantageously additions of a binder or ceramic secondary particles are possible.

A standard heat treatment process for the base nickel based alloy is used for the subsequent brazing process.

The composition of the powder mixture is described as followed in wt %:

a braze: 5%-15%,

### a NiCoCrAlY: 80%-60%,

a Nickel based superalloy: 10%-30%,
especially Alloy 247, wherein the melting point of the braze is at least 10K, especially 20K lower than the melting point of the nickel or cobalt based superalloy.

As melting point the solidus temperature or liquidus temperature can be choosen, but in the same manner for all constituents.

The mixture comprises, especially consists of 3 powders with different compositions.

The advantages are: • High oxidation resistant material made from standard powder alloys; •Standard welding process “powder cladding” can be used for blade tip build up welding

The metallic powder mixture comprises the nickel (Ni) base superalloy comprises (in wt %): especially consists of (in wt %):

| | |
|---|---|
| Carbon (C) | 0.05%-0.20% |
| especially | 0.07%-0.17% |
| Chromium (Cr) | 8.0%-23.0% |
| especially | 12.0%-23.0% |
| Cobalt (Co) | 8.0%-19.0% |
| especially | 9.0%-10.0% |
| very especially | 18.0%-19.0% |
| Tungsten (W) | 2.0%-10.0% |
| especially | 2.0%-4.5% |
| very especially | 9.0%-10.0% |
| Titanium (Ti) | 0.6%-5.0% |
| Aluminum (Al) | 1.0%-6.0% |
| optionally | |
| Boron (B) | 0.005%-0.03% |
| especially | 0.006%-0.015% |
| Molybdenum (Mo) | 0.0%-4.5% |
| especially | 0.50%-4.0% |
| Tantalum (Ta) | 0.0%-4.5% |
| especially | 1.0%-4.5% |
| Hafnium (Hf) | 0.6%-1.5% |
| Zirconium (Zr) | 0.02%-0.12% |
| Niobium (Nb) | 0.5%-1.0% |

especially no Yttrium (Y) and/or

### no Rhenium (Re),

remainder Nickel (Ni),
especially
the nickel (Ni) base superalloy comprises,
especially consists of (in wt %):

| | |
|---|---|
| Nickel (Ni) | 61.6% |
| Carbon (C) | 0.08% |
| Chromium (Cr) | 8.25% |
| Cobalt (Co) | 9.25% |
| Molybdenum (Mo) | 0.50% |
| Tungsten (W) | 9.50% |
| Titanium (Ti) | 0.75% |
| Aluminum (Al) | 5.55% |
| Boron (B) | 0.02% |
| Tantalum (Ta) | 3.20% |
| Hafnium (Hf) | 1.30%. |

especially no Yttrium (Y) and/or

### no Rhenium (Re).

Advantageously the nickel based super alloy is selected from alloy247, Inconel625, Rene 80 and/or Mer172, especially alloy247.

Inconel 625 comprises (in wt %):

| | |
|---|---|
| C | 0.03-0.10% |
| Si | ≤0.5% |
| Mn | ≤0.5% |
| P | ≤0.020% |
| S | ≤0.015% |
| Ti | ≤0.40% |
| Cr | 20.0-23.0% |
| Mo | ≤8.0-10.0% |
| Ni | ≥58.0% |
| Cu | ≤0.5% |
| Nb | 3.15-4.15% |
| Al | ≤0.4% |
| Fe | ≤5.0% |
| Co | ≤1.0%. |

Rene 80 comprises (in wt %):

### Ni=60.0%

### Cr=14.0%

### Co=9.5%

### Ti=5.0%

### Mo=4.0%

### W=4.0%

### Al=3.0%

### C=0.17% a

### B=0.015%

### Zr=0.03%.

Merl 72 comprises (in wt %):

### 47% Co

### 20% Cr

### 15% Ni

### 9.0% W

### 4.4% Al

### 3.0% Ta

### 1.1% Hf

### 0.35% C

### 0.2% Ti

### 0.04% Y.

The braze alloy comprises advantageously, especially consists of (in wt %):

| | |
|---|---|
| Nickel (Ni) | 51.70%-52.40% |
| Chromium (Cr) | 14.00%-14.25% |
| Cobalt (Co) | 19.00%-19.60% |
| Aluminum (Al) | 8.00%-8.30% |
| Tantalum (Ta) | 0.55%-0.75% |
| Molybdenum (Mo) | 0.09%-0.12% |
| Hafnium (Hf) | 0.22%-0.30% |
| Tungsten (W) | 1.60%-2.20% |
| Titanium (Ti) | 0.70%-1.10% |
| Yttrium (Y) | 0.18%-0.22% |
| Rhenium (Re) | 0.90%-1.10% |
| Carbon (C) | 0.10%-0.20% |
| Zirconium (Zr) | 0.90%-1.80% |

Especially the braze alloy comprises, especially consists of (in wt %):

| | |
|---|---|
| Nickel (Ni) | 52.00% |
| Chromium (Cr) | 14.00% |
| Cobalt (Co) | 19.30% |
| Aluminum (Al) | 8.10% |
| Tantalum (Ta) | 0.65% |
| Molybdenum (Mo) | 0.10% |
| Hafnium (Hf) | 0.25% |
| Tungsten (W) | 1.90% |
| Titanium (Ti) | 0.90% |
| Yttrium (Y) | 0.21% |
| Rhenium (Re) | 1.05% |
| Carbon (C) | 0.20% |
| Zirconium (Zr) | 1.35%. |

The melt depressant Zirconium (Zr) in the braze alloy is at least partially replaced by or it is additionally added: Silicon (Si) and/or Magnesium (Mg) and/or Mangan (Mn).

NiCoCrAlY alloy means also optionally NiCoCrAlY—X wherein X=Tantal (Ta), Silicon (Si), Rhenium (Re) and/or Iron (Fe), especially consists of these elements.

The NiCoCrAlY composition advantageously comprises (in wt %):

### 20%-22% Chromium (Cr),

### 10.5%-11.5% Aluminum (Al),

### 0.3%-0.5% Yttrium (Y),

### 1.5%-2.5% Rhenium (Re) or

between 0.5%-1.5% Rhenium and

### 11%-13% Cobalt (Co) and

a remainder Nickel (Ni).

Further advantageously example for NiCoCrAlY composition comprises (in wt %) 15%-21% Chromium (Cr),

### 24%-26% Cobalt (Co),

### 9.0%-11.5% Aluminum (Al),

### 0.05%-0.7% Yttrium (Y),

### 0.5%-2.0% Rhenium (Re) and

a remainder Nickel.

Further example of a NiCoCrAlY composition comprises (in wt %):

### 22%-24% Cobalt (Co),

### 14%-16% Chromium (Cr),

### 10.5%-11.5% Aluminum (Al),

### 0.2%-0.4% Yttrium (Y),

optional 0.3%-0.9% Tantalum (Ta),
remainder Nickel (Ni).

### BRIEF DESCRIPTION OF THE DRAWINGS

FIG. 1 shows a method how to apply the inventive material during welding and FIG. 2 shows a schematic arrangement to use the inventive powder for additive manufacturing, especially via laser.

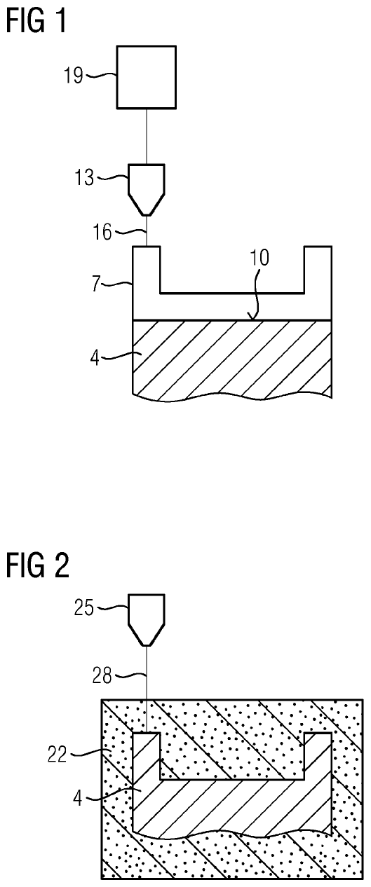

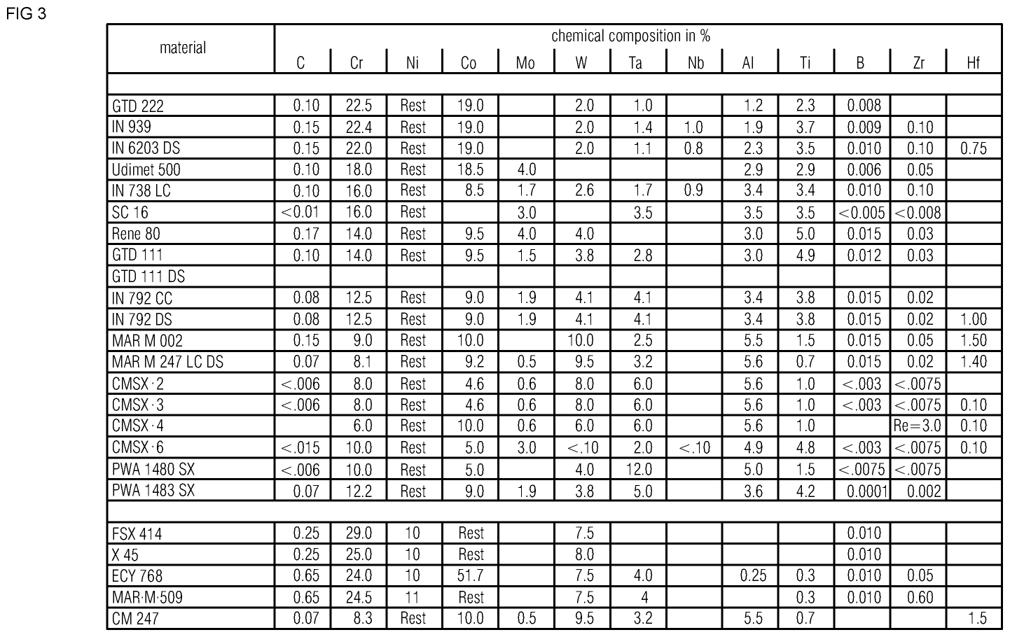

### DETAILED DESCRIPTION OF INVENTION

The description and the figures are only examples of the invention.

This method and the material can be used to build up totally new component starting on a base plate or to repair an existing substrate 4 which both means a build up of material.

The build up of material is necessary to erosion or cracks which have been removed. In this case, only for example, a blade tip is repaired by building up the material onto a blade tip 7. The surface 10 of the substrate 4 reveals the base on which the material is applied on. The material 16 is applied via a nozzle 13 which is connected to a powder supply 19 is an inventive material. The nozzle 13 also includes a laser which together with the powder 16 is used for welding by melting the powder via a laser beam (not shown).

The inventive material can also be produced as a rod and or a wire and can be used via wire welding.

In FIG. 2 another application of the inventive material is shown.

Here a selective laser melting process (also electron beams can be used instead of a laser) wherein a powder bed 22 with the inventive powder mixture is used to create a totally new component or even to repair a substrate 4.

The substrate 4 is totally inside the powder bed 22 and a laser 25 with a laser beam 28 is used to melt or to sinter partially a powder where a material build up onto the substrate 4 where it is needed or wanted.

The inventive material is a metallic powder mixture of three different powders.

Especially the powder mixture comprises alloy 247 or generally a nickel based super alloy and a NiCoCrAlY, and also comprises optionally additions like Rhenium (Re), Tantalum (Ta) and/or Silicon (Si), and a braze alloy which has at least a melting point at least 20K lower than the nickel based super alloy.

Further examples for the nickel base super alloy are listed in FIG. 3.

1. A metallic powder mixture, especially usable for build up via liquid metal deposition or any additive manufacturing method, comprising, especially consisting of (in wt %):
a cobalt (Co) or nickel (Ni) based super alloy with a content of 10% to 30%,
especially 20%,
a NiCoCrAlY—X-composition with a content of 80% to 60% and
especially 70%,
wherein X=Silicon (Si), Tantalum (Ta), Rhenium (Re) and/or Iron (Fe),
a metallic braze material with a content between 5% to 15%,
especially 10%,
wherein the melting point of the braze material is at least 10K, especially at least 20K, lower than the melting point of the cobalt (Co) or nickel (Ni) based superalloy,
especially the powder mixture consists of three powders with different compositions.

2. The metallic powder mixture according to claim 1, wherein the nickel (Ni) base superalloy comprises, especially consists of (in wt %):

| | |
|---|---|
| Carbon (C) | 0.05%-0.20% |
| especially | 0.07%-0.17% |
| Chromium (Cr) | 8.0%-23.0% |
| especially | 12.0%-23.0% |
| Cobalt (Co) | 8.0%-19.0% |
| especially | 9.0%-10.0% |
| very especially | 18.0%-19.0% |
| Tungsten (W) | 2.0%-10.0% |
| especially | 2.0%-4.5% |
| very especially | 9.0%-10.0% |
| Titanium (Ti) | 0.6%-5.0% |
| Aluminum (Al) | 1.0%-6.0% |
| optionally | |
| Boron (B) | 0.005%-0.03% |
| especially | 0.006%-0.015% |
| Molybdenum (Mo) | 0.0%-4.5% |
| especially | 0.50%-4.0% |
| Tantalum (Ta) | 0.0%-4.5% |
| especially | 1.0%-4.5% |
| Hafnium (Hf) | 0.6%-1.5% |
| Zirconium (Zr) | 0.02%-0.12% |
| Niobium (Nb) | 0.5%-1.0% |
| especially no Yttrium (Y) and/or | |
| no Rhenium (Re), | |
| remainder Nickel (Ni). | |

3. The metallic powder mixture according to claim 1, wherein the nickel (Ni) base superalloy comprises, especially consists of (in wt %):

| | |
|---|---|
| Nickel (Ni) | 61.6% |
| Carbon (C) | 0.08% |
| Chromium (Cr) | 8.25% |
| Cobalt (Co) | 9.25% |
| Molybdenum (Mo) | 0.50% |
| Tungsten (W) | 9.50% |
| Titanium (Ti) | 0.75% |
| Aluminum (Al) | 5.55% |
| Boron (B) | 0.02% |
| Tantalum (Ta) | 3.20% |
| Hafnium (Hf) | 1.30%, |

especially no Yttrium (Y) and/or
no Rhenium (Re).

4. The metallic powder mixture according to claim 1,
wherein the nickel based super alloy is selected from Alloy247, Inconel625, Rene 80 or Mer172, especially Alloy247.

5. The metallic powder mixture according to claim 1,
wherein the braze alloy comprises, especially consists of (in wt %):

| | |
|---|---|
| Nickel (Ni) | 51.70%-52.40% |
| Chromium (Cr) | 14.00%-14.25% |
| Cobalt (Co) | 19.00%-19.60% |
| Aluminum (Al) | 8.00%-8.30% |
| Tantalum (Ta) | 0.55%-0.75% |
| Molybdenum (Mo) | 0.09%-0.12% |
| Hafnium (Hf) | 0.22%-0.30% |
| Tungsten (W) | 1.60%-2.20% |
| Titanium (Ti) | 0.70%-1.10% |
| Yttrium (Y) | 0.18%-0.22% |
| Rhenium (Re) | 0.90%-1.10% |
| Carbon (C) | 0.10%-0.20% |
| Zirconium (Zr) | 0.90%-1.80%. |

6. The metallic powder mixture according to claim 1,
wherein the braze alloy comprises, especially consists of (in wt %):

| | |
|---|---|
| Nickel (Ni) | 52.0% |
| Chromium (Cr) | 14.0% |
| Cobalt (Co) | 19.30% |
| Aluminum (Al) | 8.10% |
| Tantalum (Ta) | 0.65% |
| Molybdenum (Mo) | 0.10% |
| Hafnium (Hf) | 0.25% |
| Tungsten (W) | 1.90% |
| Titanium (Ti) | 0.90% |
| Yttrium (Y) | 0.20% |
| Rhenium (Re) | 1.05% |
| Carbon (C) | 0.20% |
| Zirconium (Zr) | 1.35%. |

7. The metallic powder mixture according to claim 5,
wherein the melt depressant Zirconium (Zr) is at least partially replaced by or it is additionally added: Silicon (Si) and/or Magnesium (Mg) and/or Mangan (Mn).

8. The metallic powder mixture according to claim 1,
wherein the NiCoCrAlY—X composition comprises, especially consists of (in wt %):
14.0%-22.0% Chromium (Cr)
9.0%-11.5% Aluminum (Al)
0.3%-0.5% Yttrium (Y)
11.0%-26.0% Cobalt (Co)
0.0%-1.0% Silicon (Si),
especially 0.1%-1.0% Silicon (Si),
0.0%-2.5% Rhenium (Re)
and remainder Nickel (Ni).

9. The metallic powder mixture according to claim 1,
wherein the NiCoCrAlY—X composition comprises, especially consists of (in wt %):
20.0%-22.0% Chromium (Cr)
10.5%-11.5% Aluminum (Al)
0.3%-0.5% Yttrium (Y)
1.5%-2.5% Rhenium (Re) or between 0.5%-1.5% Rhenium
11.0%-13.0% Cobalt (Co) and
remainder Nickel.

10. The metallic powder mixture according to claim 1,
wherein the NiCoCrAlY—X composition comprises, especially consists of (in wt %):
15.0%-21.0% Chromium (Cr)
24.0%-26.0% Cobalt (Co)
9.0%-11.5% Aluminum (Al)
0.05%-0.7% Yttrium (Y)
0.5%-2.0% Rhenium (Re) and
remainder Nickel.

11. The metallic powder mixture according to claim 1,
wherein the NiCoCrAlY—X composition comprises, especially consists of (in wt %):
22.0%-24.0% Cobalt (Co)
14.0%-16.0% Chromium (Cr)
10.5%-11.5% Aluminum (Al)
0.2%-0.4% Yttrium (Y),
optional 0.3%-0.9% Tantalum (Ta) and
remainder Nickel (Ni).

12. The metallic powder mixture according to claim 1,
wherein NiCoCrAlY—X comprises, especially consists of
Nickel (Ni), Cobalt (Co), Chromium (Cr), Aluminum (Al), Yttrium (Y) or any other Rare Earth Metal,
especially only Yttrium (Y) and
optional X selected from the group Tantalum (Ta), Rhenium (Re), Silicon (Si) and/or Iron (Fe).

13. The metallic powder mixture according to claim 1,
wherein the braze alloy comprises, especially consist of (in wt %)
Nickel (Ni) 74%
Chromium (Cr) 5%
Titanium (Ti) 7.5%
Zirconium (Zr) 13.5%.

14. A powder, comprising, especially consisting of:
a mixture according to claim 1,
especially with a binder.

15. A method to build up metallic material, comprising:
building up a metallic powder mixture of claim 1.

16. The method according to claim 15,
wherein the building up of the metallic powder mixture is used for welding using powder cladding, wire welding or for additive manufacturing using powder beds,
especially SLM, SLS.

17. A product produced by a method according to claim 15.
